(19) United States
(12) Patent Application Publication
(10) Pub. No.: US 2018/0290316 A1
(43) Pub. Date: Oct. 11, 2018

(54) CUTTING DEVICE

(71) Applicant: Slice, Inc., San Jose, CA (US)

(72) Inventors: Thomas Scimone, Campbell, CA (US); Scot Herbst, Santa Cruz, CA (US)

(21) Appl. No.: 15/944,854

(22) Filed: Apr. 4, 2018

Related U.S. Application Data
(60) Provisional application No. 62/482,555, filed on Apr. 6, 2017.

(51) Int. Cl. B26B 13/28; B26B 13/20

(52) U.S. Cl. CPC B26B 13/28; B26B 13/20

(57) ABSTRACT

A cutting device is disclosed. The cutting device has a first body assembly having a first blade portion formed from a first non-magnetic material and a first handle portion formed from a second non-magnetic material. The cutting device also has a second body assembly having a second blade portion formed from the first non-magnetic material and a second handle portion formed from the second non-magnetic material. The cutting device further has a fastener formed from a third non-magnetic material, the fastener rotatably attaching the first body assembly to the second body assembly. The cutting device also has a cover assembly formed from the second non-magnetic material, the cover assembly covering the fastener. The first non-magnetic material and the second non-magnetic material are electrically non-conductive materials.

### RELATED APPLICATIONS

This application claims the benefit of U.S. Provisional Patent Application Ser. No. 62/482,555 filed Apr. 6, 2017, which is hereby incorporated by reference in its entirety.

### TECHNICAL FIELD

The present disclosure generally relates to a cutting device, and more particularly to a cutting device having non-magnetic components.

### BACKGROUND

Scissors are useful cutting tools due to their convenient size and ease of use. Many fields use components sensitive to magnetism or that may involve electrical current, e.g. medical, engineering and technology fields including computer technology. However, scissors typically contain various magnetic and electrically conductive metal parts, such as in the handle for stability and/or bolts, blades, and screws or other metal fasteners. Other scissors have bulky hinges that can interfere with their use, and are unsuitable for use in intricate work. Titanium scissors have been used in medical applications, but are expensive and uncomfortable due to their metal handles, and may be unsuitable in many non-medical fields.

Therefore, there is a need in the art for substantially non-magnetic and/or substantially electrically nonconductive cutting devices such as scissors that are comfortable to use. These and other features and advantages of the present invention will be explained and will become apparent to one skilled in the art through the summary of the invention that follows.

### SUMMARY OF THE DISCLOSURE

In one exemplary aspect, the present disclosure is directed to a cutting device. The cutting device includes a first body assembly having a first blade portion formed from a first non-magnetic material and a first handle portion formed from a second non-magnetic material. The cutting device also includes a second body assembly having a second blade portion formed from the first non-magnetic material and a second handle portion formed from the second non-magnetic material. The cutting device further includes a fastener formed from a third non-magnetic material, the fastener rotatably attaching the first body assembly to the second body assembly. The cutting device also includes a cover assembly formed from the second non-magnetic material, the cover assembly covering the fastener. The first non-magnetic material and the second non-magnetic material are electrically non-conductive materials.

In another aspect, the present disclosure is directed to a cutting device. The cutting device includes a first body assembly having a first blade portion formed from a first non-magnetic material and a first handle portion formed from a second non-magnetic material. The cutting device also includes a second body assembly having a second blade portion formed from the first non-magnetic material and a second handle portion formed from the second non-magnetic material. The cutting device further includes a fastener formed from a third non-magnetic material, the fastener rotatably attaching the first body assembly to the second body assembly. The cutting device also includes a cover assembly formed from the second non-magnetic material, the cover assembly covering the fastener. The first non-magnetic material is a ceramic material.

### BRIEF DESCRIPTION OF THE DRAWINGS

FIG. 1 is a perspective view of an exemplary cutting device in accordance with an embodiment of the present invention;

FIG. 2 is a perspective view of an exemplary cutting device in accordance with an embodiment of the present invention;

FIG. 3 is a side view of an exemplary cutting device in accordance with an embodiment of the present invention;

FIG. 4 is a side view of an exemplary cutting device in accordance with an embodiment of the present invention;

FIG. 5 is a side view of an exemplary cutting device in accordance with an embodiment of the present invention;

FIG. 6 is a front view of an exemplary cutting device in accordance with an embodiment of the present invention;

FIG. 7 is a back view of an exemplary cutting device in accordance with an embodiment of the present invention;

FIG. 8 is a side view of an exemplary cutting device in accordance with an embodiment of the present invention;

FIG. 9 is a sectional view of an exemplary cutting device in accordance with an embodiment of the present invention;

FIG. 10 is a sectional view of an exemplary cutting device in accordance with an embodiment of the present invention; and

FIG. 11 is an exploded view of an exemplary cutting device in accordance with an embodiment of the present invention.

### DETAILED DESCRIPTION AND INDUSTRIAL APPLICABILITY

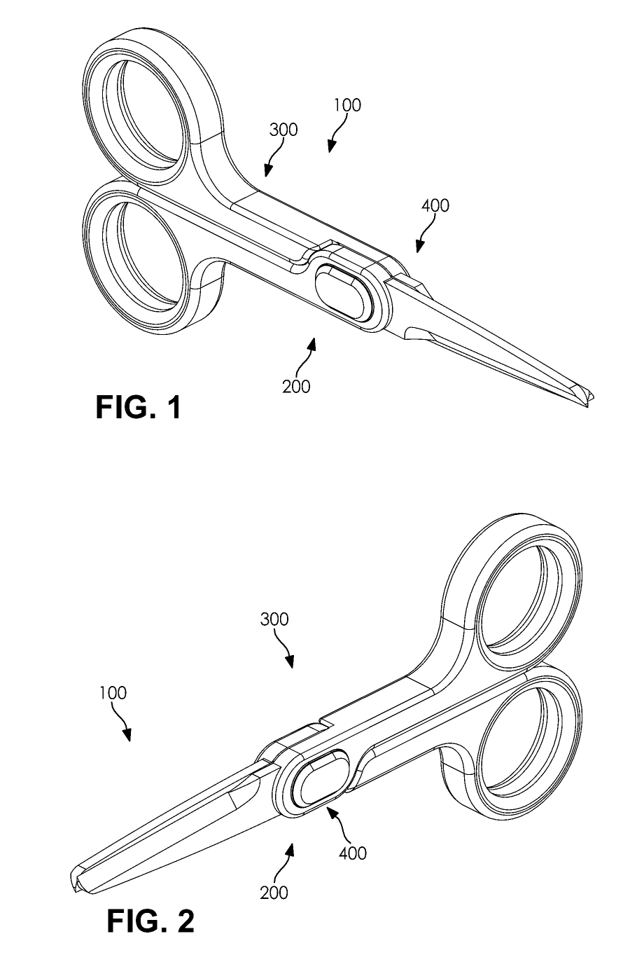

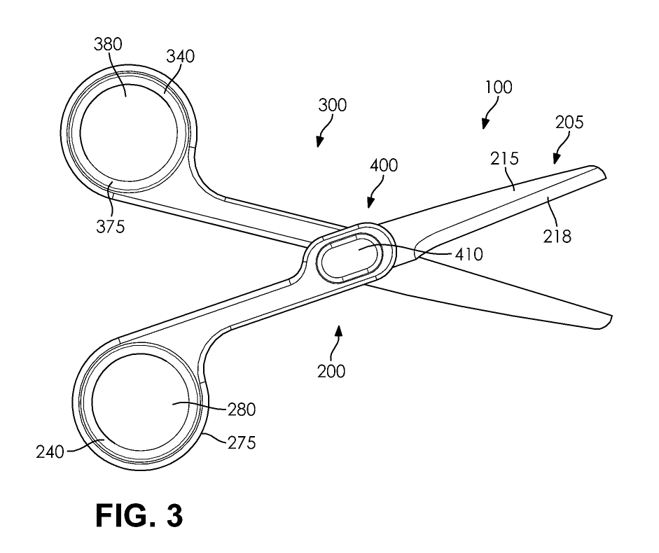

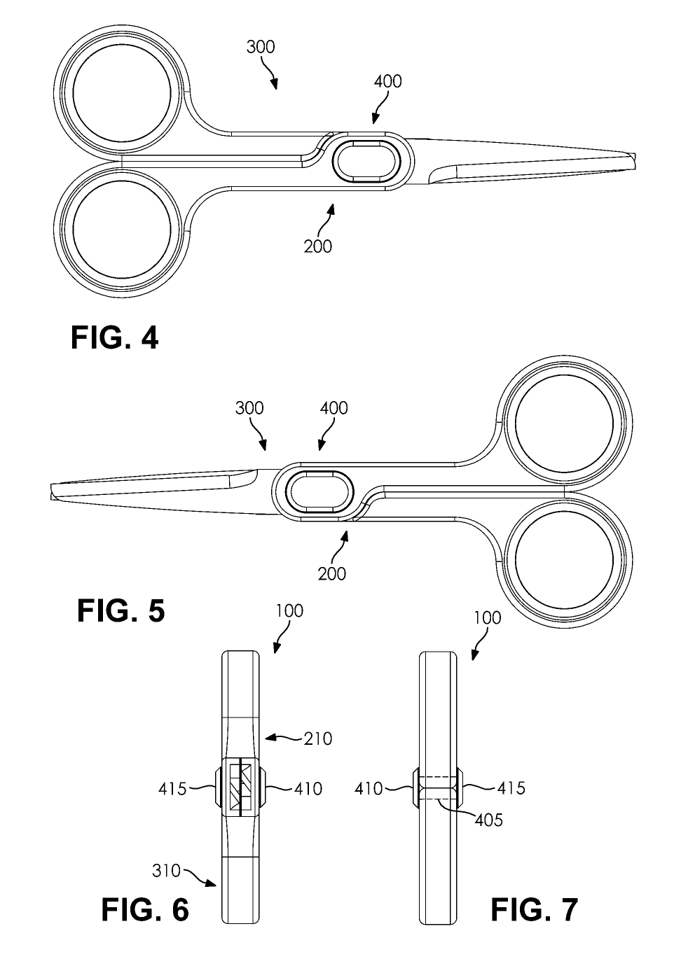

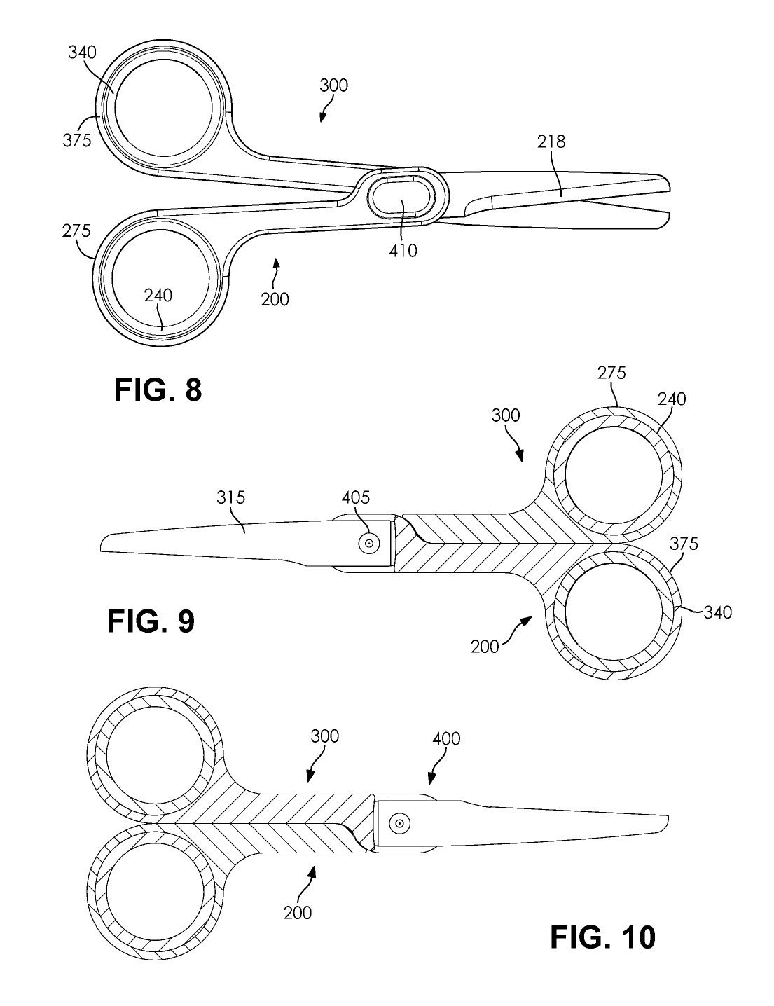

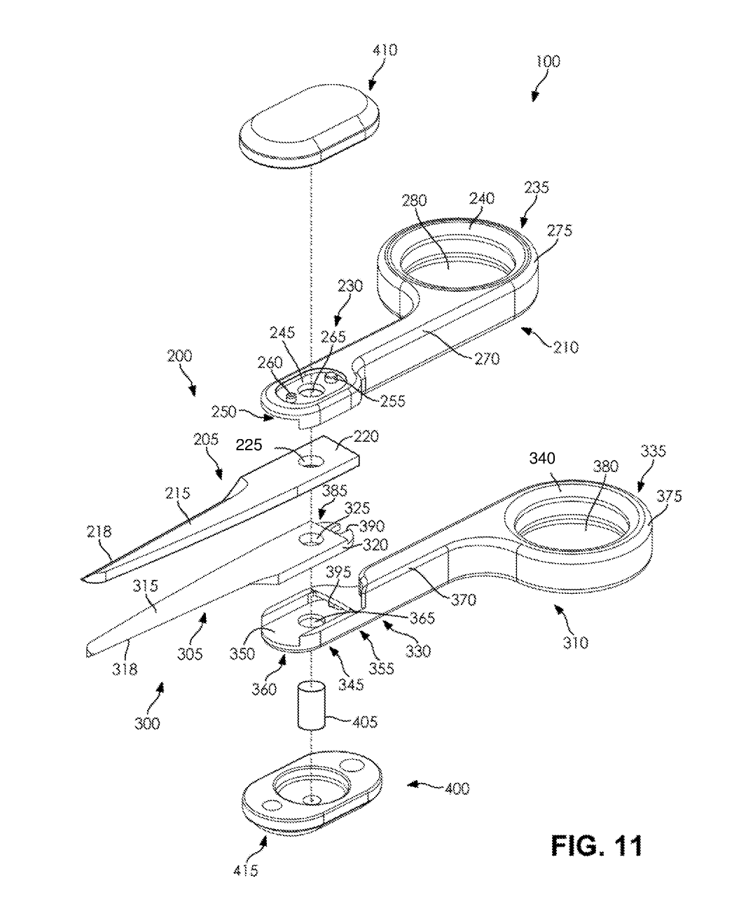

FIGS. 1-11 illustrate an exemplary cutting device 100. The exemplary cutting device disclosed herein may be any suitable device for cutting material such as, for example, a pair of scissors, a craft knife, a seam ripper, a box cutter, a utility knife, or a precision knife. For example, cutting device 100 may be a pair of scissors for cutting material. For example, FIGS. 1 and 2 illustrate a perspective view of exemplary cutting device 100 in a closed position, FIG. 3 illustrates a side view of cutting device 100 in an open position, FIGS. 4 and 5 illustrate side views of cutting device 100 in a closed position, FIG. 6 illustrates a front view of cutting device 100, FIG. 7 illustrates a back view of cutting device 100, FIG. 8 illustrates a side view of an additional open position of cutting device 100, FIGS. 9 and 10 illustrate sectional views of cutting device 100, and FIG. 11 illustrates an exploded view showing various components of cutting device 100.

Cutting device 100 may include a body assembly 200, a body assembly 300, and a hinge assembly 400. Hinge assembly 400 may rotatably connect body assembly 200 and body assembly 300. As disclosed for example herein, cutting device 100 may be formed from substantially (e.g., substantially fully) non-magnetic material and (e.g., some or all) electrically non-conductive material.

Body assembly 200 may include a blade portion 205 and a handle portion 210. Blade portion 205 and handle portion 210 may be attached (e.g., attached in a fixed manner) together to form body assembly 200, which may be for example a scissor half of a pair of scissors (e.g., when cutting device 100 is a pair of scissors, body assembly 200 and body assembly 300 may be scissor halves).

Blade portion 205 may include a cutting portion 215, a connecting portion 220, and an aperture 225. Aperture 225 may be, for example, a pivot hole that may receive a portion of hinge assembly 400 as disclosed for example herein. Aperture 225 may thereby be disposed at a point of rotation (e.g., a pivot point) of body assembly 200 relative to body assembly 300 and hinge assembly 400. In addition to being disposed on blade portion 205, aperture 225 may also be located for example on handle portion 210 (e.g., aperture 225 may be located at any suitable location for providing a pivot point for the operation of cutting device 100).

Connecting portion 220 may for example be a portion extending from cutting portion 215 for attachment to a portion of handle portion 210. Cutting portion 215 may include a portion 218 that may be used for cutting material. Portion 218 may be a relatively narrow portion (e.g., narrower relative the other portions of cutting portion 215) of cutting portion 215 that may serve to cut material. For example, portion 218 may be the relatively narrow cutting end (e.g., sharp end) of a blade such as the cutting end of a blade such as a scissor blade. For example, portion 218 may be configured as a blade having a rounded tip or any other suitable configuration that may reduce the chance of unintentional cutting (e.g., accidents or injury) to users or others. For example, portion 218 (e.g., the relatively narrow blade or portion 218 of cutting portion 215) may be about 25 mm to about 65 mm long from tip to where the relatively narrow or sharp portion ends (for example 40-50 mm, e.g., 45 mm).

Cutting portion 215 and connecting portion 220 may be integral portions of blade portion 205 that may be a single, continuous member. For example, cutting portion 215 and connecting portion 220 may be portions of a single, continuous member (e.g., integrally formed as a single member) formed from the same material. It is also contemplated that cutting portion 215 and connecting portion 220 may be separate members that are attached together (e.g., attached in a fixed manner).

Blade portion 205 may for example be formed from a substantially non-magnetic, substantially electrically non-conductive material. For example, blade portion 205 may be formed from any suitable material for cutting that is substantially non-magnetic (e.g., having a low magnetic permeability such as for example materials having substantially non-magnetic properties such as many metals, alloys, and/or polymers) and substantially non-conductive (e.g., having a low electrical conductivity such as for example materials having conductivity σ in Siemens/meter at 20° C. of for example about 10⁻⁶ or less, e.g., or of about 10⁻³ or less). For example, blade portion 205 may be formed from any suitable materials for cutting having substantially non-magnetic properties (e.g., about as non-magnetic or less magnetic than many metals and alloys) and substantially non-conductive properties (e.g., materials having about the conductivity or less conductivity than materials such as titanium, silicon, and/or wood).

For example, blade portion 205 may be formed from a ceramic material that is capable of withstanding extended use without becoming dull or unusable. For example, blade portion 205 may be formed from Zirconium Oxide, as well as from additional ceramic materials that are substantially non-magnetic, substantially electrically non-conductive materials suitable for use in a cutting device for cutting material. Also for example, blade portion 205 may be formed from other suitable substantially non-magnetic, substantially non-conductive materials such as for example non-magnetic metallic materials, titanium, and/or non-metallic steel.

Handle portion 210 may include a connecting portion 230, a grip portion 235, and an insert portion 240. Handle portion 210 may be attached to blade portion 205 via connecting portion 230, and a user may hold cutting device 100 at grip portion 235 and insert portion 240.

Connecting portion 230 may include a cavity 245 and a cavity 250. Cavity 245 may be shaped and sized to receive a portion of an exemplary cover as disclosed herein. Cavity 250 may be shaped and size to receive connecting portion 220. A plurality of protrusions 255 and 260 may be disposed in cavity 245 and may be received within exemplary recesses of an exemplary cover to help attach the exemplary cover to connecting portion 230 as disclosed herein. Connecting portion 230 may also include an aperture 265 that may be aligned with aperture 225 of blade portion 205 when connecting portion 220 is received in cavity 250. Connecting portion 230 may also include a portion 270 (e.g., an elongated member or a shank) that may be integral with or attached to grip portion 235.

Grip portion 235 may include a portion 275 that may for example form an aperture 280 with which a user may grip cutting device 100. For example, aperture 280 may form a gripping aperture for use by a user (e.g., when cutting device 100 is a pair of scissors, aperture 280 may be a finger hole). For example, aperture 280 may be sized to allow a user to fit one or several fingers into aperture 280 for gripping cutting device 100. Connecting portion 230 and grip portion 235 may be integral portions of a single, continuous member. For example, connecting portion 230 and grip portion 235 may be portions of a single, continuous member (e.g., integrally formed as a single member) formed from the same material as disclosed for example herein. It is also contemplated that connecting portion 230 and grip portion 235 may be separate members that are attached together (e.g., attached in a fixed manner).

Insert portion 240 may be received within aperture 280, with an exterior surface of insert portion 240 being sized to fit (e.g., fit tightly) within a surface of portion 275 forming aperture 280. Insert portion 240 may be attached in a fixed manner to portion 275 forming aperture 280 by any suitable manner such as, for example, using adhesive, a friction-fit attachment device, a snap-fit attachment device, and/or any suitable mechanical fastener. Alternatively, insert portion 240 may also be an integral portion of handle portion 210, for example with connecting portion 230, grip portion 235, and insert portion 240 being portions of a single, continuous member (e.g., integrally formed as a single member) and formed from the same material as disclosed for example herein.

Body assembly 300 may be similar to body assembly 200. For example when cutting device 100 is a pair of scissors, body assembly 200 and body assembly 300 may be scissor halves that are rotatably connected by hinge assembly 400 that may for example be positioned substantially in the middle of the width of each of body assembly 200 and body assembly 300. For example, body assembly 300 may have a blade portion 305 including a cutting portion 315, a portion 318, a connecting portion 320 and an aperture 325 that may be similar respectively to blade portion 205 including cutting portion 215, portion 218, connecting portion 220 and aperture 225. Also, body assembly 300 may have a handle portion 310 including a connecting portion 330, a grip portion 335, an insert portion 340, a cavity 345, a cavity 350, a protrusion 355, a protrusion 360, an aperture 365, a portion 370, a portion 375, and an aperture 380 that may be similar respectively to handle portion 210 including connecting portion 230, grip portion 235, insert portion 240, cavity 245, cavity 250, protrusion 255, protrusion 260, aperture 265, portion 270, portion 275, and aperture 280. Also for example, connecting portions 220 and/or 320 may include a portion 385 having for example a recess 390 that may receive for example a protrusion 395 disposed in cavity 250 and/or 350 for helping to fit connecting portions 220 and/or 320 into respective connecting portions 230 and/or 330.

Also for example, handle portions 210 and/or 310 may be ambidextrous and/or symmetrical, with insert portions 240 and 340 having a similar size and/or shape (e.g., or insert portions 240 and 340 may have different shapes to facilitate for example use by left-handed or right-handed users). For example, apertures 280 and/or 380 and insert portions 240 and/or 340 may be circular (e.g., to facilitate precision work by a user). Also for example, apertures 280 and/or 380 and insert portions 240 and/or 340 may be oval or may be of larger, smaller, and/or of a different shape from each other (for example, one of apertures 280 or 380 and insert portions 240 or 340 may be an upper circular finger/thumb hole and the other of apertures 280 or 380 and insert portions 240 or 340 may be a lower oval finger hole to accommodate two or three fingers of a user). Further for example, at least one of handle portion 210 and handle portion 310 may include an aperture (e.g., aperture 280 or 380) in which an insert portion (e.g., insert portion 240 or 340) formed from a non-magnetic material (e.g., as disclosed herein) is disposed.

Hinge assembly 400 may include a fastener 405, a cover 410, and a cover 415. Fastener 405 may be received in apertures 225 and 265 of body assembly 200 and apertures 325 and 365 of body assembly 300. For example when body assembly 200 and body assembly 300 are aligned as illustrated in FIG. 11, fastener 405 may be received in apertures 225, 265, 325, and 365 to fasten cutting device 100 as illustrated in FIGS. 1-10. Body assembly 200 may rotate relative to body assembly 300 about fastener 405. For example, fastener 405 may rotatably attach body assembly 200 to body assembly 300.

Cover 410 and cover 415 may cover fastener 405. For example, cover 410 and cover 415 may form a cover assembly that covers fastener 405. For example, cover 410 may be attached to connecting portion 230, and cover 415 may be attached to connecting portion 330. Also for example, cover 410 may include a plurality of recesses for receiving protrusions 255 and 260, and cover 415 may include a plurality of recesses for receiving protrusions 355 and 360. Covers 410 and cover 415 may be respectively attached to connecting portions 230 and 330 by any suitable technique, such as for example by adhesive, a friction-fit attachment device, a snap-fit attachment device, and/or any suitable mechanical fastener.

Fastener 405 may be for example a screw, a bolt, a rivet, or any other suitable fastener type that can be configured to not protrude (e.g., to not significantly protrude) out of cavities 245 and/or 345. Fastener 405 may be formed from a substantially non-magnetic metallic material such as, for example, a non-magnetic steel alloy (e.g., non-magnetic metallic alloy such as an austenitic steel). For example, fastener 405 may be formed from an austenitic steel that may include chromium-nickel (300 series), manganese-chromium-nickel-nitrogen (200 series), and/or specialty alloys. For example, fastener 405 may be formed from 304 stainless steel and/or 316 stainless steel. For example, fastener 405 may be formed from a suitable non-magnetic material having a responsiveness to magnetic fields that is negligible (e.g., due to a relatively high concentration of e.g. chromium and nickel and a specific lattice structure of the chemical bonds between those elements). For example, fastener 405 may be formed from 304 stainless steel having about 18% or more chromium (e.g., 18-20% chromium), and/or about 8% or more nickel (e.g., about 8-10.50% nickel). Also for example, fastener 405 may be formed from molybdenum-alloyed steel and/or any other suitable material for a fastener that is negligibly responsive to magnetic fields. Further for example, fastener 405 may be formed from any other suitable non-magnetic metals or metal alloys such as, for example, copper, tin, titanium, zinc, brass, and/or bronze.

Fastener 405 may be for example a non-bulky fastener that may not significantly protrude from a surface of handle portions 210 and/or 310. For example as illustrated in FIG. 7, fastener 405 may have a length in a direction extending through apertures 225, 265, 325, and 365 that is substantially equal to or less than a width of handle portions 210 and 310 (e.g., overall width of cutting device 100 at handle portions 210 and 310) when fastened to each other. For example, a length of fastener 405 may be substantially equal to or less than a width of cutting device 100 at a connection portion (e.g., at a portion where handle portions 210 and 310 are attached via fastener 405) of body assembly 200 and body assembly 300. For example, this exemplary non-bulky configuration of fastener 405 may avoid edges of fastener 405 catching onto a material that is being cut by a user and/or catching onto objects or equipment in a tight working environment.

Handle portion 210, handle portion 310, insert portion 240, insert portion 340, cover 410, and/or cover 415 may be formed from substantially non-magnetic material and/or substantially electrically non-conductive material. For example, handle portion 210, handle portion 310, insert portion 240, insert portion 340, cover 410, and/or cover 415 may be formed from substantially non-magnetic parts and substantially electrically non-conductive materials such as, for example, polymer materials and plastic materials, e.g., thermoplastic and thermosetting polymers, resins and elastomers, polyethylene, polystyrene, polypropylene, epoxy resins, phenolic resins, and/or any other suitable material having desired strength and flexibility for forming structural components of cutting device 100. For example, handle portion 210, handle portion 310, insert portion 240, insert portion 340, cover 410, and/or cover 415 may be formed from any suitable material that is substantially non-magnetic (e.g., having a low magnetic permeability such as for example materials having substantially non-magnetic properties such as many metals, alloys, and/or polymers) and substantially electrically non-conductive (e.g., having a low electrical conductivity such as for example materials having conductivity σ in Siemens/meter at 20° C. of for example about 10⁻⁶ or less, e.g., of about 10⁻³ or less).

Also for example, handle portion 210, handle portion 310, cover 410, and/or cover 415 may be formed from substantially non-magnetic material and/or substantially electrically non-conductive material such as reinforced materials, e.g., materials reinforced by other materials or fibers such as glass fibers or carbon fibers. For example, handle portion 210, handle portion 310, cover 410, and/or cover 415 may be formed from a glass-filled material such as a glass-filled polymer material or a glass-filled plastic material. For example, handle portion 210, handle portion 310, cover 410, and/or cover 415 may be formed from glass-filled polymer and/or glass-filled plastic (e.g., a moldable composite material including short glass-fibers in a matrix of a polymer material that may involve exemplary methods of manufacture such as injection or compression molding). For example, handle portion 210, handle portion 310, cover 410, and/or cover 415 may be formed from a thermoplastic or thermosetting polymer or resin that may be used as a matrix, for example, polyamide/nylon, acetal homopolymers and copolymers, polyester, polyphenylene oxide (PPO/Noryl), polycarbonate, and polyethersulphone. Also for example, handle portion 210, handle portion 310, cover 410, and/or cover 415 may be formed from material that may be pre-mixed from fibers and polymer or resin, with optional additions of catalyst (e.g. polyester) or hardener (e.g. epoxy) before molding or manufacture. Further for example, handle portion 210, handle portion 310, cover 410, and/or cover 415 may be formed from fiber-filled polymer material such as glass-filled polymer (e.g. glass-filled nylon including about 5-45% filled glass material or more, for example, about 10-40%, about 13-30%, or about 20%).

Further for example, insert portion 240 and/or insert portion 340 may be formed from substantially non-magnetic material and/or substantially electrically non-conductive material such as relatively soft plastic and/or polymer materials (e.g., that may be arranged around some or all of an inner surface or circumference of portion 275). For example, insert portion 240 and/or insert portion 340 may be formed from thermoplastic material, thermosetting elastomer material (e.g., elastic polymer), natural rubber, and/or synthetic rubber. For example, insert portion 240 and/or insert portion 340 may be formed from copolymers of multiple materials and/or physical mixes of materials, including for example thermoplastic polymers and/or thermosetting polymers. For example, insert portion 240 and/or insert portion 340 may be formed from materials such as styrenic block copolymers (TPE-s), thermoplastic olefins (TPE-o), elastomeric alloys (TPE-v or TPV), thermoplastic polyurethanes (TPU), thermoplastic copolyester (TPE-E), and/or thermoplastic polyamides. Further for example, insert portion 240 and/or insert portion 340 may be formed from rubber material such as silicone rubber material. Additionally for example, insert portion 240 and/or insert portion 340 may be formed from any suitable relatively soft, substantially non-magnetic material and/or substantially electrically non-conductive material such as, for example, material having durometer scale (e.g., durometer scale of Shore A) values that are “soft,” “medium soft,” and/or “medium hard” as measured on a Shore Hardness Scale. For example, insert portion 240 and/or insert portion 340 may be formed from material having Shore A Hardness values of between about 5 A and about 80 A. For example, insert portion 240 and/or insert portion 340 may be formed from “soft,” “medium soft,” and/or “medium hard” material having Shore A Hardness values of between about 8 A and about 80 A, between about 15 A and about 70 A, between about 25 A and about 60 A, and/or between about 30 A and about 60 A. For example, insert portion 240 and/or insert portion 340 may be formed from “soft” and/or “medium soft” material having Shore A Hardness values of between about 15 A and about 60 A, between about 20 A and about 50 A, between about 20 A and about 45 A, and/or between about 25 A and about 40 A.

For example, cutting device 100 may be a pair of substantially fully non-magnetic scissors. For example, cutting device 100 may be a pair of scissors having substantially non-magnetic blade portions 205 and 305, and hinge assembly 400 having substantially non-magnetic fastener 405. Also for example, cutting device 100 may be a pair of substantially electrically non-conductive scissors having ceramic blade portions 205 and 305, substantially non-magnetic fastener 405 that may be covered with substantially electrically non-conductive (and/or substantially non-magnetic) covers 410 and 415 on each side of fastener 405, and handle portions 210 and 310 and insert portions 240 and 340 formed from substantially electrically non-conductive (and/or substantially non-magnetic) materials.

Also for example, some portions or substantially the entire exemplary cutting device may be formed by 3D printing (also known as “additive” manufacturing), CNC machined parts (also known as “subtractive” manufacturing) and/or injection molding.

Further for example, handle portions 210 and/or 310 may be configured with structural fastening elements on or in their surface to allow insert portion 240, insert portion 340, cover 410, and/or cover 415 to be securely fastened to handle portions 210 and/or 310 respectively, and insert portion 240, insert portion 340, cover 410, and/or cover 415 may have corresponding structural fastening elements on and/or in their inside surfaces to engage with such structural fastening elements. For example, handle portion 210, handle portion 310, insert portion 240, insert portion 340, cover 410, and/or cover 415 may include matching nut and groove and/or pin and hole structures. Also for example, insert portion 240, insert portion 340, cover 410, and/or cover 415 may be securely fastened to respective handle portions 210 and/or 310 chemically, thermally, and/or by ultrasound (e.g. ultrasound welding of plastic parts).

Additionally for example, a total length from an end portion (e.g. tip) of blade portions 205 and 305 (e.g., when in a closed position as illustrated in FIGS. 1 and 2) to end portions of handle portions 210 and 310 (e.g., distal to the tip of blade portions 205 and 305) may be for example between about 105 mm and about 145 mm, between about 115 mm and about 135 mm, about 125 mm, and/or of any suitable dimensions for a cutting device. Also for example, a length from an end portion (e.g. tip) of blade portions 205 and 305 to a center of fastener 405 may be for example between about 40 mm and about 80 mm, between about 50 mm and about 70 mm, about 60 mm, and/or of any suitable dimensions for a cutting device. Further for example, a length from a center of fastener 405 to end portions of handle portions 210 and 310 (e.g., distal to the tip of blade portions 205 and 305) may be slightly longer than the above exemplary lengths from blade tip to hinge center (e.g., an additional length of about 0.5-4.5 mm, for example about 2-3 mm, about 2.5 mm, and/or any suitable additional length for a cutting device).

It is also contemplated that the exemplary cutting device may be any suitable cutting device such as a pair of scissors, a craft knife, a seam ripper, a box cutter, a utility knife, a precision knife, or any suitable cutting device having for example blade portions, handle portions, and/or a hinge assembly.

The exemplary disclosed cutting device and method may provide a substantially non-magnetic and/or substantially electrically nonconductive cutting device. The exemplary disclosed cutting device and method may be used in any application involving a cutting device that is non-magnetic and/or electrically non-conductive and also comfortable for a user to use. For example, the exemplary cutting device may be used in any cutting application involving components sensitive to magnetism and/or that may involve electrical current such as, for example, medical, manufacturing, electrical and mechanical engineering, computer technology, laboratory, robotics, and/or other technology fields.

A user may utilize cutting device 100 to comfortably and safely cut material in applications involving components sensitive to magnetism and/or involving electricity. A left-handed user, a right-handed user, or an ambidextrous user may grip cutting device 100 by inserting one or more fingers through each of insert portions 240 and 340. The user may move his or her fingers to move handle portions 210 and 310 toward and away from each other as desired when cutting material, which moves blade portions 205 and 305 toward and away from each other based on respective rotation of body assembly 200 and body assembly 300 about hinge assembly 400 (e.g., body assembly 200 and body assembly 300 rotate about hinge assembly 400 based on rotation about fastener 405 that is received in apertures 225, 265, 325, and 365). By rotating body assembly 200 and body assembly 300 relative to each other about hinge assembly 400 during for example cutting of a material, a user may move cutting device 100 from a closed position illustrated in FIGS. 1 and 2 to any desired open position (e.g., as illustrated in FIGS. 3 and 8).

The exemplary disclosed device and method may provide a substantially non-magnetic and/or non-conductive cutting device that may be comfortably used by a user. For example, the exemplary disclosed substantially non-magnetic cutting device may be comfortably used by a user in applications involving components that may be sensitive to magnetism so that such components are not negatively affected by the cutting device. Also for example, the exemplary disclosed substantially electrically non-conductive cutting device may be comfortably used by a user in applications involving electricity and electrical current so that the probability of injury to a user and/or damage to equipment due to unintentional conduction of electricity may be avoided. Further, the exemplary disclosed cutting device may be a non-bulky device without protruding edges that may catch onto a material that is being cut and/or objects in a tight working environment.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed cutting device and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A cutting device, comprising:
a first body assembly having a first blade portion formed from a first non-magnetic material and a first handle portion formed from a second non-magnetic material;
a second body assembly having a second blade portion formed from the first non-magnetic material and a second handle portion formed from the second non-magnetic material;
a fastener formed from a third non-magnetic material, the fastener rotatably attaching the first body assembly to the second body assembly; and
a cover assembly formed from the second non-magnetic material, the cover assembly covering the fastener;
wherein the first non-magnetic material and the second non-magnetic material are electrically non-conductive materials.

2. The cutting device of claim 1, wherein the first non-magnetic material is a ceramic material or a titanium material.

3. The cutting device of claim 1, wherein the third non-magnetic material is austenitic steel.

4. The cutting device of claim 1, wherein the fastener is a screw, bolt, or rivet formed from the third non-magnetic material that is austenitic steel.

5. The cutting device of claim 1, wherein the second non-magnetic material is a polymer material or a plastic material.

6. The cutting device of claim 1, wherein the second non-magnetic material is a glass-filled material.

7. The cutting device of claim 1, wherein at least one of the first handle portion and the second handle portion includes an aperture in which an insert portion formed from a fourth non-magnetic material is disposed.

8. The cutting device of claim 7, wherein the fourth non-magnetic material is a soft or medium material as measured on a Shore Hardness Scale.

9. The cutting device of claim 7, wherein the fourth non-magnetic material has a Shore A Hardness value of between about 20 A and about 50 A.

10. The cutting device of claim 1, wherein the first non-magnetic material and the second non-magnetic material are electrically non-conductive materials having a conductivity σ in Siemens/meter at 20° C. of about 10⁻³ or less.

11. A cutting device, comprising:
a first body assembly having a first blade portion formed from a first non-magnetic material and a first handle portion formed from a second non-magnetic material;
a second body assembly having a second blade portion formed from the first non-magnetic material and a second handle portion formed from the second non-magnetic material;
a fastener formed from a third non-magnetic material, the fastener rotatably attaching the first body assembly to the second body assembly; and
a cover assembly formed from the second non-magnetic material, the cover assembly covering the fastener;
wherein the first non-magnetic material is a ceramic material.

12. The cutting device of claim 11, wherein the first non-magnetic material and the second non-magnetic material are electrically non-conductive materials.

13. The cutting device of claim 11, wherein at least one of the first blade portion and the second blade portion includes a blade having a rounded tip.

14. The cutting device of claim 11, wherein the first non-magnetic material is Zirconium Oxide.

15. The cutting device of claim 11, wherein the second non-magnetic material is a glass-filled nylon material.

16. A pair of scissors, comprising:
a first scissor half having a first blade portion formed from a first non-magnetic material and a first handle portion formed from a second non-magnetic material;
a second scissor half having a second blade portion formed from the first non-magnetic material and a second handle portion formed from the second non-magnetic material;
a fastener formed from a non-magnetic metallic alloy material, the fastener rotatably attaching the first scissor half to the second scissor half; and
a cover assembly formed from the second non-magnetic material, the cover assembly covering the fastener;
wherein the first non-magnetic material is a ceramic material; and
wherein a length of the non-magnetic steel alloy fastener is substantially equal to or less than a width of the pair of scissors at a connection portion of the first and second scissor halves.

17. The pair of scissors of claim 16, wherein the first non-magnetic material and the second non-magnetic material are electrically non-conductive materials.

18. The pair of scissors of claim 16, wherein the non-magnetic metallic alloy material is austenitic steel.

19. The pair of scissors of claim 16, wherein at least one of the first handle portion and the second handle portion includes an aperture in which an insert portion is formed, the insert portion being a soft or medium non-magnetic material as measured on a Shore Hardness Scale.

20. The pair of scissors of claim 19, wherein the soft or medium non-magnetic material has a Shore A Hardness value of between about 20 A and about 45 A.
